(19) United States
(12) Patent Application Publication
(10) Pub. No.: US 2006/0002487 A1
(43) Pub. Date: Jan. 5, 2006

(54) Methods and apparatus for parametric estimation in a multiple antenna communication system

(76) Inventors: Kai Roland Kriedte, Utrecht (NL); Syed Aon Mujtaba, Berkeley Heights, NJ (US); Xiaowen Wang, Bridgewater, NJ (US)

Correspondence Address: Ryan, Mason & Lewis, LLP, Suite 205, 1300 Post Road, Fairfield, CT, 06824, US

(21) Appl. No.: 10/990,344

(22) Filed: Nov. 16, 2004

(30) Foreign Application Priority Data
Jun. 30, 2004 (WO) PCT/US04/21026
Jun. 30, 2004 (WO) PCT/US04/21027
Jun. 30, 2004 (WO) PCT/US04/21028

(51) Int. Cl. H04L 1/02

(52) U.S. Cl. 375/267

(57) ABSTRACT

Methods and apparatus are disclosed for processing received data in a multiple input multiple output (MIMO) communication system. A multiple antenna receiver can distinguish a MIMO transmission from other transmissions based on the detection of a predefined symbol following a legacy portion of a preamble. A preamble comprises a legacy portion and an extended portion. The legacy portion is comprised of a first long preamble followed by a first signal field and may be processed by both multiple antenna receivers and legacy receivers. The extended portion comprises the predefined symbol following the first signal field from the legacy portion. If the predefined symbol is a second long preamble, a MIMO transmission is detected by performing a correlation on the preamble to detect the second long preamble. If the predefined symbol is a second long signal field, a MIMO transmission is detected by performing a cyclic redundancy check to detect the second long signal field.

### CROSS REFERENCE TO RELATED APPLICATIONS

This application is related to International Patent Application Numbers PCT/US04/21026, PCT/US04/21027 and PCT/US04/21028, each filed Jun. 30, 2004 and incorporated by reference herein.

### FIELD OF THE INVENTION

The present invention relates generally to wireless communication systems, and more particularly, to techniques for channel estimation, timing acquisition, and MIMO format detection for a multiple antenna communication system.

### BACKGROUND OF THE INVENTION

Most existing Wireless Local Area Network (WLAN) systems based upon Orthogonal Frequency Division Multiplexing (OFDM) techniques comply with the IEEE 802.11a or IEEE 802.11g Standards (hereinafter “IEEE 802.11a/g”). See, e.g., IEEE Std 802.11a-1999, “Part 11: Wireless LAN Medium Access Control (MAC) and Physical Layer (PHY) Specification: High-Speed Physical Layer in the Five GHz Band,” incorporated by reference herein. In IEEE 802.11a/g wireless LANs, the receiver must obtain synchronization and channel state information for every packet transmission. Thus, a preamble is inserted at the beginning of each packet that contains training symbols to help the receiver extract the necessary synchronization and channel state information.

Multiple transmit and multiple receive antennas have been proposed to increase robustness and capacity of a wireless link. Multiple Input Multiple Output (MIMO) OFDM techniques, for example, transmit separate data streams on multiple transmit antennas, and each receiver receives a combination of these data streams on multiple receive antennas. In order to properly receive the different data streams, MIMO-OFDM receivers must acquire synchronization and channel information for every packet transmission. A MIMO-OFDM system needs to estimate a total of NₜNᵣ channel profiles, where Nₜ is the number of transmit antennas and Nᵣ is the number of receive antennas.

It is desirable for a MIMO-OFDM system to be backwards compatible with existing IEEE 802.11a/g receivers, since they will operate in the same shared wireless medium. A legacy system that is unable to decode data transmitted in a MIMO format should defer for the duration of the transmission. This can be achieved by detecting the start of the transmission and retrieving the length (duration) of this transmission. A need exists for a method and system for performing channel estimation and training in a MIMO-OFDM system that is compatible with current IEEE 802.11a/g standard systems, thus allowing MIMO-OFDM based WLAN systems to efficiently co-exist with SISO systems.

### SUMMARY OF THE INVENTION

Generally, methods and apparatus are disclosed for processing received data in a multiple input multiple output (MIMO) communication system. The invention allows a multiple antenna receiver that operates in a shared wireless medium to be backwards compatible with existing IEEE 802.11a/g receivers. A multiple antenna receiver can distinguish a MIMO transmission from other transmissions based on the detection of a predefined symbol following a legacy portion of a preamble. In particular, a preamble according to the invention comprises a legacy portion and an extended portion. The legacy portion is comprised of a first long preamble followed by a first signal field and may be processed by both multiple antenna receivers and legacy receivers. The extended portion comprises the predefined symbol following the first signal field from the legacy portion.

In two exemplary embodiments, the predefined symbol may be a second long preamble or a second long signal field. In an implementation where the predefined symbol is a second long preamble, a MIMO transmission is detected by performing a correlation on the preamble to detect the second long preamble. In an implementation where the predefined symbol is a second long signal field, a MIMO transmission is detected by performing a cyclic redundancy check to detect the second long signal field.

A more complete understanding of the present invention, as well as further features and advantages of the present invention, will be obtained by reference to the following detailed description and drawings.

### BRIEF DESCRIPTION OF THE DRAWINGS

FIG. 1 illustrates a conventional frame format in accordance with the IEEE 802.11a/g standard;

FIGS. 2A and 2B are schematic block diagrams of a conventional transmitter and receiver, respectively;

FIGS. 3A and 3B illustrate the transmission of information in SISO and MIMO systems, respectively;

FIG. 4 illustrates the timing synchronization for the exemplary MIMO system of FIG. 3B;

FIGS. 5A and 5B are schematic block diagrams of a MIMO transmitter and receiver, respectively;

FIG. 6 illustrates an exemplary preamble format that may be used in a MIMO system;

FIG. 7 is a flow chart describing an exemplary receiver parametric estimation algorithm incorporating features of the present invention to process the preamble format of FIG. 6;

FIG. 8 illustrates an alternate preamble format that may be used in a MIMO system; and

FIG. 9 is a flow chart describing an exemplary receiver parametric estimation algorithm incorporating features of the present invention to process the preamble format of FIG. 8.

### DETAILED DESCRIPTION

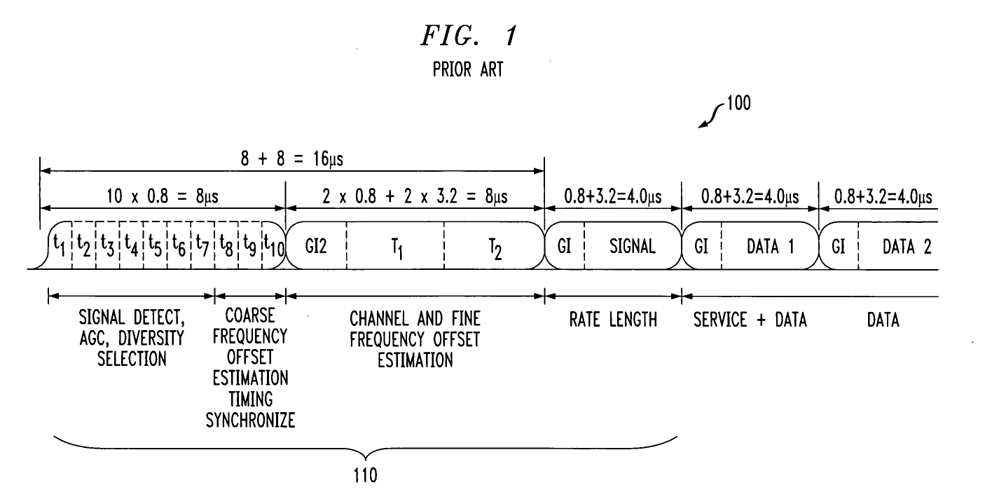

FIG. 1 illustrates a conventional frame format 100 in accordance with the IEEE 802.11a/g standards. As shown in FIG. 1, the frame format 100 comprises ten short training symbols, t1 to t10, collectively referred to as the Short Preamble. Thereafter, there is a Long Preamble, consisting of a protective Guard Interval (GI2) and two Long Training Symbols, T1 and T2. A SIGNAL field is contained in the first real OFDM symbol, and the information in the SIGNAL field is needed to transmit general parameters, such as packet length and data rate. The Short Preamble, Long Preamble and Signal field comprise a legacy header 110. The OFDM symbols carrying the DATA follows the SIGNAL field.

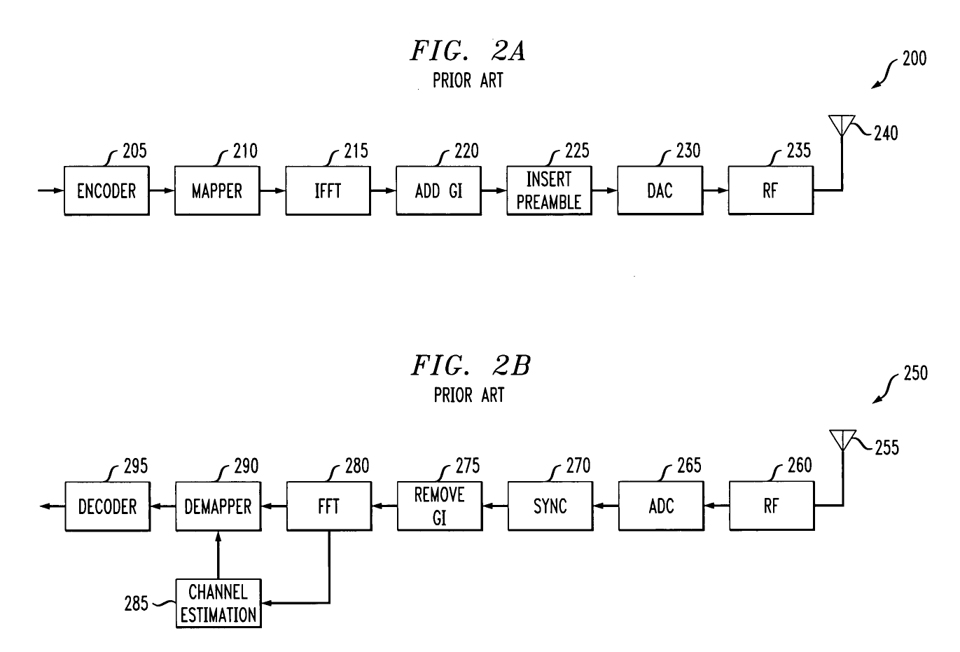

FIG. 2A is a schematic block diagram of a conventional transmitter 200 in accordance with the exemplary IEEE 802.11a/g standard. As shown in FIG. 2A, the transmitter 200 encodes the information bits using an encoder 205 and then maps the encoded bits to different frequency tones (subcarriers) using a mapper 210. The signal is then transformed to a time domain wave form by an IFFT (inverse fast Fourier transform) 215. A guard interval (GI) of 800 nanoseconds (ns) is added in the exemplary implementation before every OFDM symbol by stage 220 and a preamble of 20 μs is added by stage 225 to complete the packet. The digital signal is then converted to an analog signal by converter 230 before the RF stage 235 transmits the signal on an antenna 240.

FIG. 2B is a schematic block diagram of a conventional receiver 250 in accordance with the exemplary IEEE 802.11a/g standard. As shown in FIG. 2B, the receiver 250 processes the signal received on an antenna 255 at an RF stage 260. The analog signal is then converted to a digital signal by converter 265. The receiver 250 processes the preamble to detect the packet, and then extracts the frequency and timing synchronization information at the synchronization stage 270. The guard interval is removed at stage 275. The signal is then transformed back to the frequency domain by an FFT 280. The channel estimates are derived at stage 285 using the frequency domain long training symbols. The channel estimates are used by the demapper 290 to extract soft symbols, that are then fed to the decoder 295 to extract information bits.

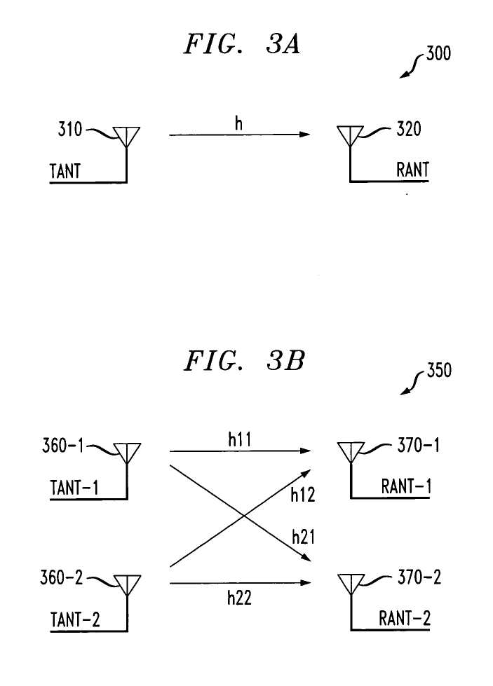

FIGS. 3A and 3B illustrates the transmission of information in SISO and MIMO systems 300, 350, respectively. As shown in FIG. 3A, the SISO transmission system 300 comprises one transmit antenna (TANT) 310 and one receive antenna (RANT) 320. Thus, there is one corresponding channel, h.

As shown in FIG. 3B, the exempary 2×2 MIMO transmission system 350 comprises of two transmit antennas (TANT-1 and TANT-2) 360-1 and 360-2 and two receive antennas (RANT-1 and RANT-2) 370-1 and 370-2. Thus, there are four channels profiles: h11, h12, h21 and h22. The additional channels makes both timing synchronization and channel estimation more challenging. In order to perform channel estimation, the training preamble of FIG. 1 needs to be lengthened.

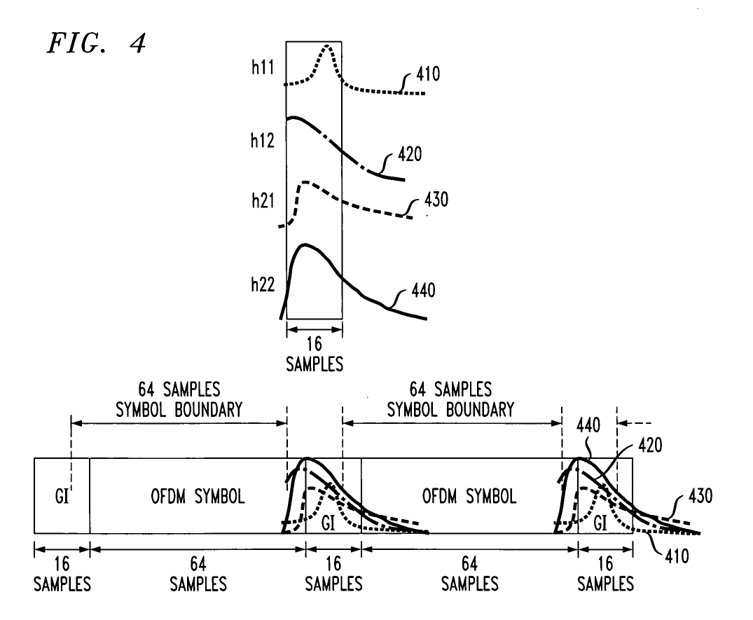

FIG. 4 illustrates the timing synchronization for the exemplary MIMO system 350 of FIG. 3B having four channels h11, h12, h21 and h22. The exemplary guard interval (GI) should be placed as a window of 800 ns (i.e., 16 Nyquist samples) that contains most of the energy of the impulse responses 410, 420, 430, 440 corresponding to the four channels h11, h12, h21 and h22. In other words, the guard interval is positioned to find the optimum 64 sample window for the OFDM symbol within the 80 sample window (that most avoids the four impulse responses). For the MIMO case, the guard interval window should be chosen to maximize the total power of all four channels.

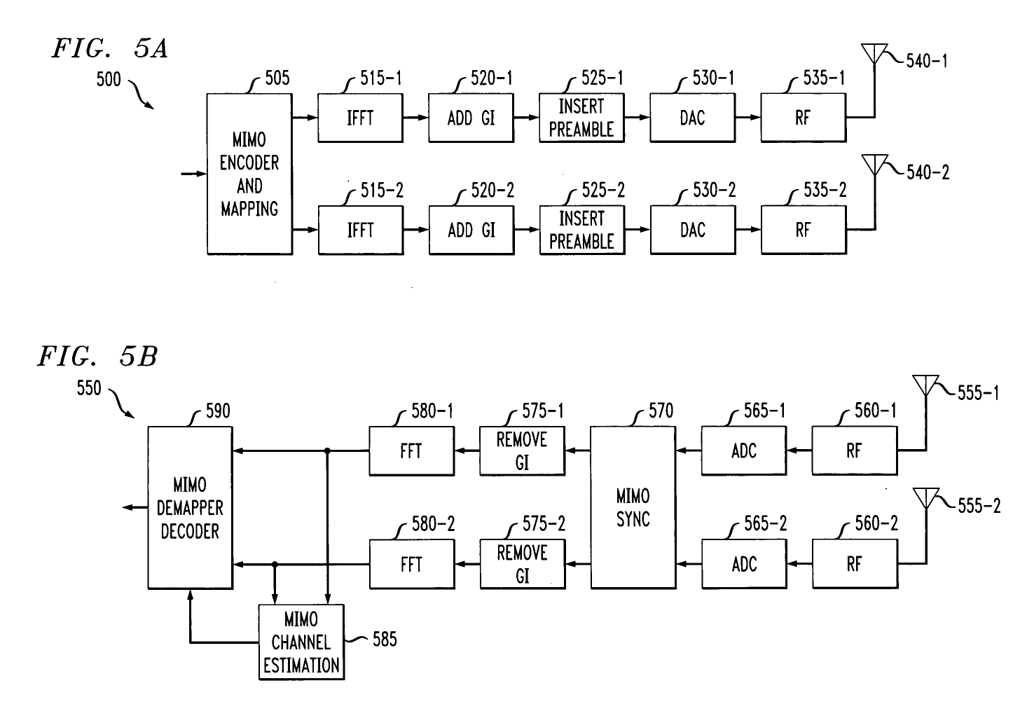

FIG. 5A is a schematic block diagram of a MIMO transmitter 500. As shown in FIG. 5A, the transmitter 500 encodes the information bits and maps the encoded bits to different frequency tones (subcarriers) at stage 505. For each transmit branch, the signal is then transformed to a time domain wave form by an IFFT (inverse fast Fourier transform) 515. A guard interval (GI) of 800 nanoseconds (ns) is added in the exemplary implementation before every OFDM symbol by stage 520 and a preamble of 32 μs is added by stage 525 to complete the packet. The digital signal is then converted to an analog signal by converter 530 before the RF stage 535 transmits the signal on a corresponding antenna 540.

FIG. 5B is a schematic block diagram of a MIMO receiver 550. As shown in FIG. 5B, the exemplary 2×2 receiver 550 processes the signal received on two receive antennas 555-1 and 555-2 at corresponding RF stages 560-1, 560-2. The analog signals are then converted to digital signals by corresponding converters 565. The receiver 550 processes the preamble to detect the packet, and then extracts the frequency and timing synchronization information at synchronization stage 570 for both branches. The guard interval is removed at stage 575. The signal is then transformed back to the frequency domain by an FFT at stage 580. The channel estimates are obtained at stage 585 using the long training symbol. The channel estimates are applied to the demapper/decoder 590, and the information bits are recovered.

As previously indicated, a MIMO-OFDM system should be backwards compatible with existing IEEE 802.11a/g receivers. A MIMO system that uses at least one long training field of the IEEE 802.11a/g preamble structure repeated on different transmit antennas can scale back to a one-antenna configuration to achieve backwards compatibility. A number of variations are possible for making the long training symbols backwards compatible. In one variation, the long training symbols can be diagonally loaded across the various transmit antennas. In another variation, 802.11a long training sequences are repeated in time on each antenna. For example, in a two antenna implementation, a long training sequence, followed by a signal field is transmitted on the first antenna, followed by a long training sequence transmitted on the second antenna. A further variation employs MIMO-OFDM preamble structures based on orthogonality in the time domain.

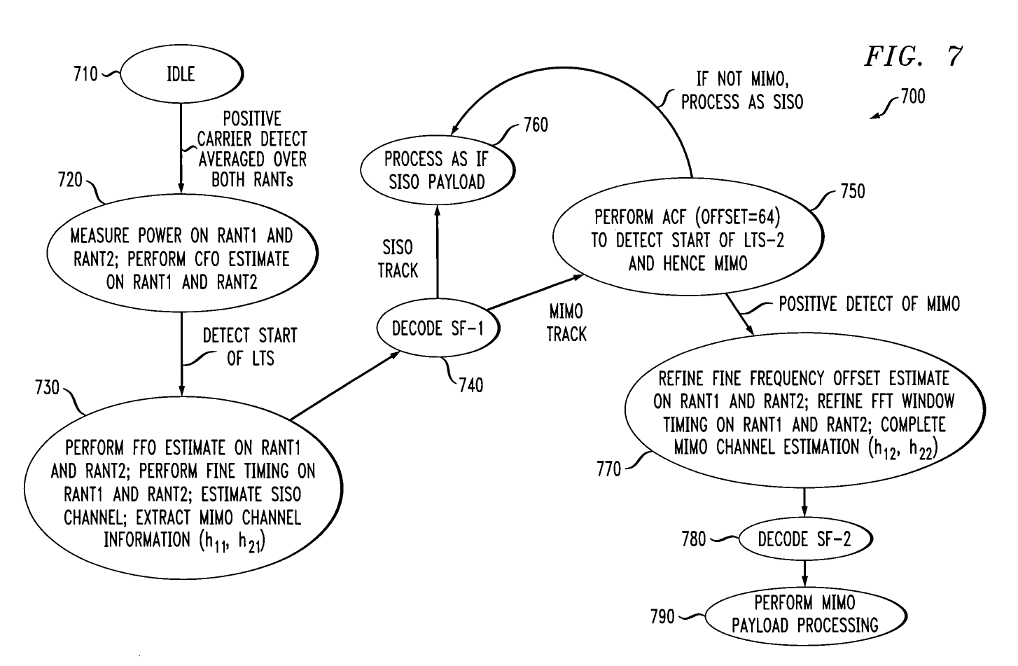

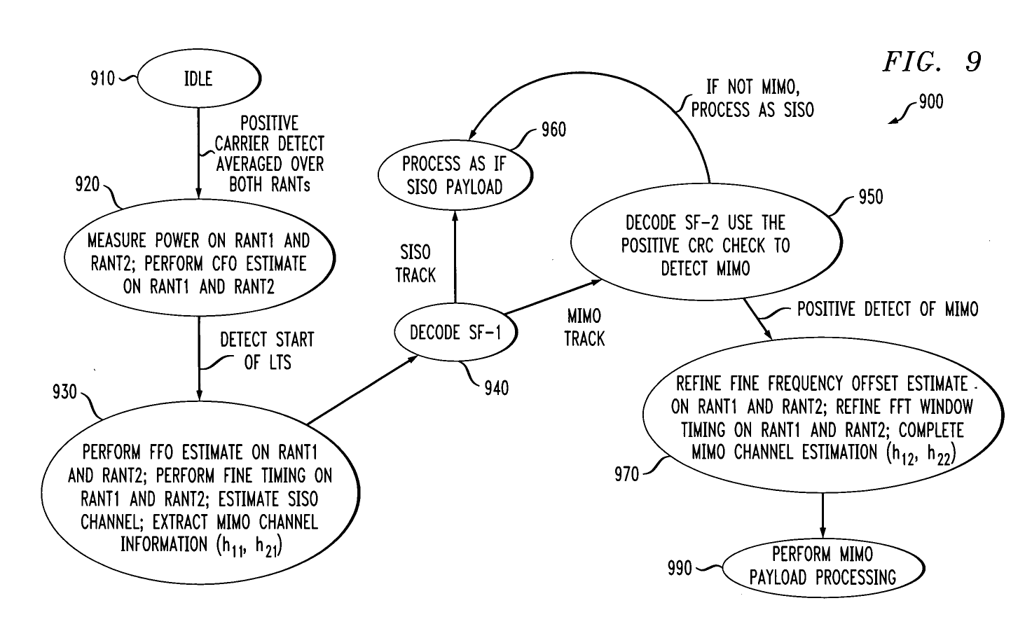

According to one aspect of the present invention, a parametric estimation algorithm at the receiver, discussed further below in conjunction with FIGS. 7 and 9, provides the multiple training needed in a MIMO system to get the improved frequency offset estimation, optimal timing offset estimation and complete channel estimation. Moreover, using the two signaling schemes in this invention, the receiver can effectively detect the MIMO transmission while still maintaining backwards compatibility.

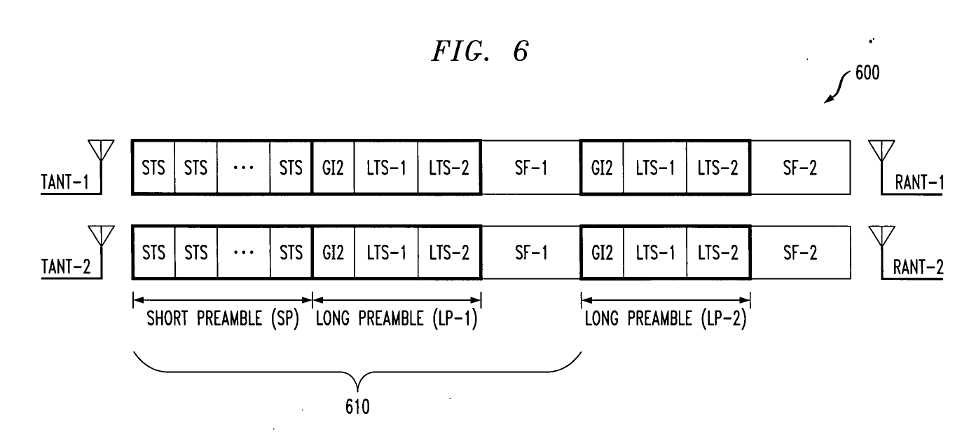

FIG. 6 illustrates an exemplary preamble format 600 using the long preamble for MIMO signaling. In the preamble format 600 of FIG. 6, the first long preamble LP-1 is sent after the short preamble SP-1. SP-1 consists of 10 identical short training symbols (STS). LP-1 consists of extended GI (GI2), and two identical long training symbols, LTS-1 and LTS-2. The first signal field, SF1, which is the same as the 802.11a/g legacy signal field, is transmitted after the first long preamble LTS-1. The Short Preamble STS-1, first Long Preamble LTS-1 and the first Signal field SF-1 comprise a legacy header 610.

Thereafter, the second long preamble LP-2 is transmitted and then an optional second signal field SF-2. The first and second long preambles LP-1, LP-2 are constructed using the 802.11a/g long preamble with a long guard interval of 1.6 μs and two indentical long training symbols, LTS-1 and LTS-2. The long preambles LP-1, LP-2 transmitted from different transmitter antennas at different time are all derived from the 802.11a/g long training symbols. The first signal field SF-1 transmitted from different antennas is derived in the same fashion as the first long trainig symbol. The MIMO data follows the second signal field SF-2.

The first short preamble SP-1 is used by both receive branches RANT-1 and RANT-2 to perform carrier detection, power measurement (automatic gain control) and coarse frequency offset estimation. The first long preamble LP-1 is used by both receive branches RANT-1 and RANT-2 to perform fine frequency offset estimation, windowed FFT timing and SISO channel estimation. The second long preamble LP-2 is used by both receive branches RANT-1 and RANT-2 to perform MIMO channel estimation, refine fine frequency offset estimation and refine the windowed FFT timing.

It is noted that in a SISO system, the receiver would expect to receive data after the first signal field SF-1. The present invention provides receiver parametric estimation algorithms 700, 900, discussed further below in conjunction with FIGS. 7 and 9, respectively, that allow a MIMO receiver 550 to detect whether a second long training preamble LP-2 will follow the first signal field SF-1 (indicating a MIMO transmission), without any explicit signaling requirement.

FIG. 7 is a flow chart describing an exemplary receiver parametric estimation algorithm 700 incorporating features of the present invention. The receiver parametric estimation algorithm 700 processes the preamble format 600 of FIG. 6. As shown in FIG. 7, the receiver parametric estimation algorithm 700 is initially in an idle mode 710 until a positive carrier is detected on both receive branches. Once a positive carrier is detected, the receiver parametric estimation algorithm 700 performs power measurements and coarse frequency offset (CFO) estimation on both receive branches during step 720.

When the start of the first long training preamble LP-1 is detected, a fine frequency offset (FFO) estimate and fine timing are performed on receive branches RANTI and RANT2 and estimates are obtained for the SISO and MIMO channels during step 730. Thereafter, the first signal field SF-1 is decoded during step 740.

The receiver parametric estimation algorithm 700 then begins processing the received signal on two parallel branches, a MIMO track and a SISO track. On the MIMO track, the long training symbol LTS-1 is correlated with LTS-2 in the second long preamble, LP-2, during srep 750. This process corresponds to an autocorrelation with an offset of 64 samples (i.e. 3.2 us). If the correlation exceeds a defined threshold, a MIMO transmission is detected.

On a parallel SISO track, the received signal is processed in a conventional manner as if it is a SISO payload. If the MIMO track does not detect the start of the second long training symbol LTS-2 during step 750, then the received signal is processed as a SISO signal during step 760. If, however, the MIMO track does detect the start of the second long training symbol LTS-2 during step 750, then the received signal is processed as a MIMO signal and program control proceeds to step 770. In particular, the MIMO transmission is processed during step 770 to refine the fine frequency offsets on both receive branches RANT1 and RANT2. As shown in FIG. 4, the optimal timing can only be acquired whan all four channel impulse responses are available, which is only possible after receiving the second long preamble LP-2. Hence, the FFT timing window is adjusted on both receive branches RANT1 and RANT2 and the MIMO channel estimation is completed. The second signal field SF-2 is decoded during step 780 and the MIMO payload is processed during step 790, before program control terminates (i.e., signifying the end-of-packet).

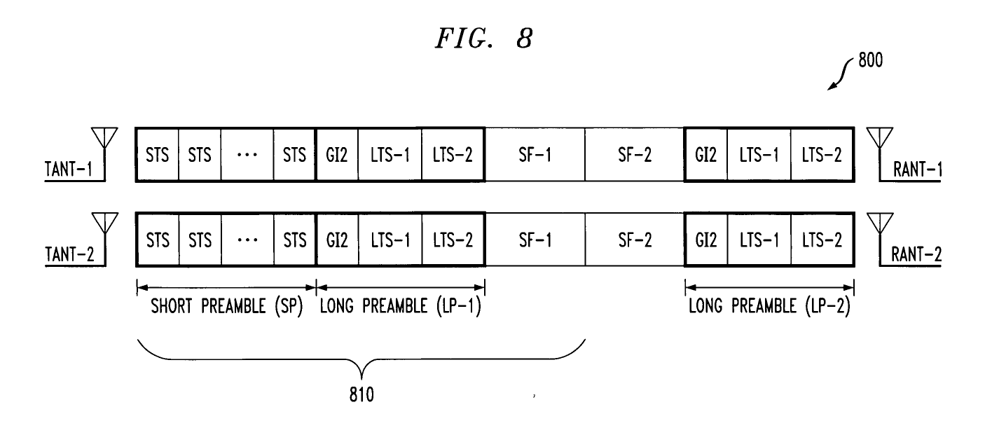

FIG. 8 illustrates an alternate preamble format 800 that uses a second signal field to signal the MIMO transmssion. As shown in FIG. 8, the alternate preamble format 800 changes the order of the second long preamble and second signal field, relative to the preamble format 600 of FIG. 6. In the alternate preamble format 800, the second signal field SF-2 is transmitted right after the first signal field SF-1 and the positive decoding of the second signal field SF-2 is used to signal the MIMO transmission. The Short Preamble SP-1, first Long Preamble LP-1 and the first Signal field SF-1 comprise a legacy header 8610.

FIG. 9 is a flow chart describing an exemplary receiver parametric estimation algorithm 900 incorporating features of the present invention. The receiver parametric estimation algorithm 900 processes the preamble format 800 of FIG. 8. As shown in FIG. 9, the receiver parametric estimation algorithm 900 is initially in an idle mode 910 until a positive carrier is detected on both receive branches. Once a positive carrier is detected, the receiver parametric estimation algorithm 900 performs power measurements and coarse frequency offset (CFO) estimation on both receive branches during step 920.

When the start of the first long training preamble LP-1 is detected, a fine frequency offset (FFO) estimate and fine timing are performed on receive branches RANT1 and RANT2 and estimates are obtained for the SISO and MIMO channels (h11 and h21) during step 930. Thereafter, the first signal field SF-1 is decoded during step 940.

The receiver parametric estimation algorithm 900 then begins processing the received signal on two parallel branches. On a MIMO track, the second signal field is decoded during step 950. A positive CRC check is used to detect the MIMO transmission. On a parallel SISO track, the received signal is processed in a conventional manner as if it is a SISO payload.

If the MIMO track does not detect the start of the second signal field SF-2 during step 950, then the received signal is processed as a SISO signal during step 960. If, however, the MIMO track does detect the start of the second signal field SF-2 during step 950, then the received signal is processed as a MIMO signal and program control proceeds to step 970. In particular, the MIMO transmission is processed during step 970 to refine the fine frequency offsets on both receive branches RANT1 and RANT2. In addition, the FFT timing window is adjusted on both receive branches RANT1 and RANT2 and the MIMO channel estimation (h22 and h12) is completed. The MIMO payload is processed during step 990, before program control terminates.

It is noted that the performance of the receiver parametric estimation algorithms 700, 900 can each be optionally improved by performing both the autocorrelation on the second Long Preamble LP-2 and the cyclic redundancy check on the second signal field SF-2.

It is to be understood that the embodiments and variations shown and described herein are merely illustrative of the principles of this invention and that various modifications may be implemented by those skilled in the art without departing from the scope and spirit of the invention.

We claim:

1. A method for processing received data in a multiple input multiple output (MIMO) communication system, said method comprising the steps of:
receiving a preamble having a legacy portion comprised of a first long preamble followed by a first signal field and an extended portion comprised of a predefined symbol following said first signal field; and
detecting a MIMO transmission based on a detection of said predefined symbol following said first signal field.

2. The method of claim 1, wherein said predefined symbol is a second long preamble.

3. The method of claim 2, wherein said detecting step further comprises the step of performing a correlation on said preamble to detect said second long preamble.

4. The method of claim 1, wherein said predefined symbol is a second long signal field.

5. The method of claim 4, wherein said detecting step further comprises the step of performing a cyclic redundancy check to detect said second long signal field.

6. The method of claim 1, wherein said legacy preamble further comprises at least one short preamble.

7. The method of claim 1, wherein said legacy preamble is an 802.11a/g preamble.

8. The method of claim 1, whereby a lower order receiver can interpret said received data.

9. The method of claim 1, whereby a lower order receiver can defer for a MIMO transmission.

10. The method of claim 1, further comprising the step of detecting a SISO transmission if said predefined symbol does not follow said first signal field.

11. The method of claim 1, further comprising the step of processing a remaining portion of said preamble if a MIMO transmission is detected.

12. A receiver in a multiple antenna communication system, comprising:
a plurality of antennas for receiving signals comprised of a preamble having a legacy portion comprised of a first long preamble followed by a first signal field and an extended portion comprised of a predefined symbol following said first signal field; and
a MIMO detector for detecting a MIMO transmission based on a detection of said predefined symbol following said first signal field.

13. The receiver of claim 12, wherein said predefined symbol is a second long preamble.

14. The receiver of claim 13, wherein said detection performs a correlation on said preamble to detect said second long preamble.

15. The receiver of claim 12, wherein said predefined symbol is a second long signal field.

16. The receiver of claim 15, wherein said detection performs a cyclic redundancy check to detect said second long signal field.

17. The receiver of claim 12, wherein said legacy preamble further comprises at least one short preamble.

18. The receiver of claim 12, whereby a lower order receiver can defer for a MIMO transmission.

19. A method for processing received data in a multiple input multiple output (MIMO) communication system, said method comprising the step of:
detecting a MIMO transmission based on a detection of a predefined symbol in a received signal that follows a legacy preamble.

20. The method of claim 19, wherein said predefined symbol is a second long preamble or a second signal field following said legacy preamble.
